(19) United States
(12) Patent Application Publication
(10) Pub. No.: US 2010/0252668 A1
(43) Pub. Date: Oct. 7, 2010

(54) CUTTER FOR CUTTING SCRAP WIRE

(75) Inventors: AI-JIA TANG, Shenzhen City (CN); DONG-MIN ZHANG, Shenzhen City (CN); KE LIU, Shenzhen City (CN); KUO-JUNG HUANG, Tu-Cheng (TW); YAO-TSER LIU, Tu-Cheng (TW); CHENG-YU WANG, Tu-Cheng (TW); CHUN-HSIEN CHIANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/506,419

(22) Filed: Jul. 21, 2009

(30) Foreign Application Priority Data
Apr. 2, 2009 (CN) 200920301882.X

(51) Int. Cl. B02C 19/00; B23D 25/14

(52) U.S. Cl. 241/236; 83/344; 83/345

(57) ABSTRACT

A cutter is provided to cut scrap wire into pieces. The cutter includes a base with a fixed shaft and a floating shaft parallel to the fixed shaft, a resilient connection device supporting the floating shaft, a master gear rotatably mounted on the fixed shaft, and a slave gear rotatably mounted on the floating shaft and engaging the master gear. Teeth of the master gear are pointed and an angle of the teeth of the master gear is less than 60°. A force provided by the resilient connection device is parallel to the center lines of the master gear and the slave gear, and when scrap wire is fed into the cutter, the master gear and the slave gear collectively cut the scrap wire into pieces.

### BACKGROUND

1. Technical Field

The disclosure relates to cutters for cutting scrap wire.

2. Description of Related Art

In low speed wire electrical discharge machining (LS-WEDM), different wires are required to machine different workpieces. Often, scrap wire is simply discarded in a workplace, resulting in inefficient use of space and process.

Therefore, a need exists in the industry to overcome the described limitations.

### BRIEF DESCRIPTION OF THE DRAWINGS

FIG. 1 is an exploded, perspective view of a cutter in accordance with an exemplary embodiment of the disclosure.

FIG. 2 is an assembled view of FIG. 1.

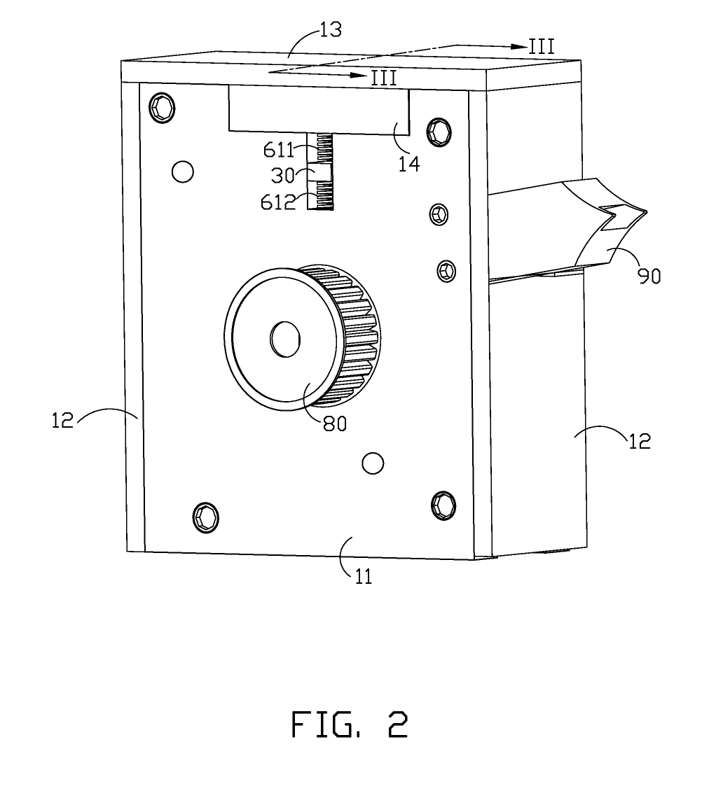

FIG. 3 is a cross section along line III-III of FIG. 2.

FIG. 4 is an enlarged, schematic view of a master gear of FIG. 1.

### DETAILED DESCRIPTION

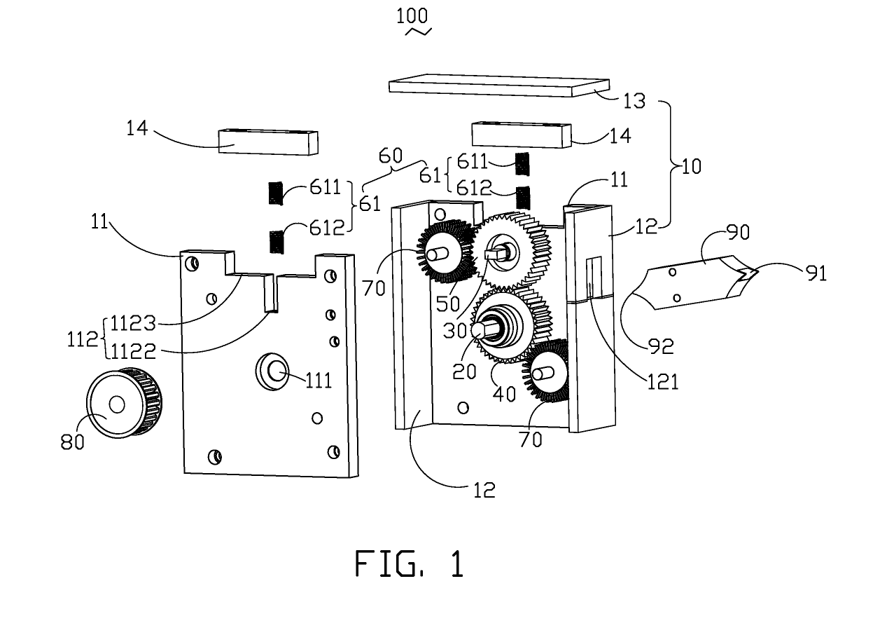

FIG. 1 is an exploded, perspective view of a cutter in accordance with an exemplary embodiment of the disclosure. The cutter 100 is provided for cutting scrap wire into pieces, and includes a base 10, a fixed shaft 20, a floating shaft 30, a master gear 40, a slave gear 50 and a resilient connection device 60. When the scrap wire is fed into the cutter 100, the master gear 40 and the slave gear 50 engage to cut the scrap wire into pieces.

The base 10 includes a pair of supporting boards 11 opposite to each other, a pair of sideboards 12 opposite to each other, a covering board 13, and a pair of blocks 14. The pair of supporting boards 11 and the pair of sideboards 12 are connected with each other to define a receiving space therein. The covering board 13 is on top of the receiving space, that is, the base 10 is a housing shaped with an opening in the bottom thereof. The pair of blocks 14 are oppositely disposed between the covering board 13 and a corresponding supporting board 11.

Each of the pair of supporting boards 11 defines a shaft hole 111 located in a middle portion thereof, in which two ends of the fixed shaft 20 are received, respectively. The master gear 40 is rotatably mounted on the fixed shaft 20. One of the two ends of the fixed shaft 20 extends through a corresponding shaft hole 111 to connect with a driving device (not shown) rotating the master gear 40.

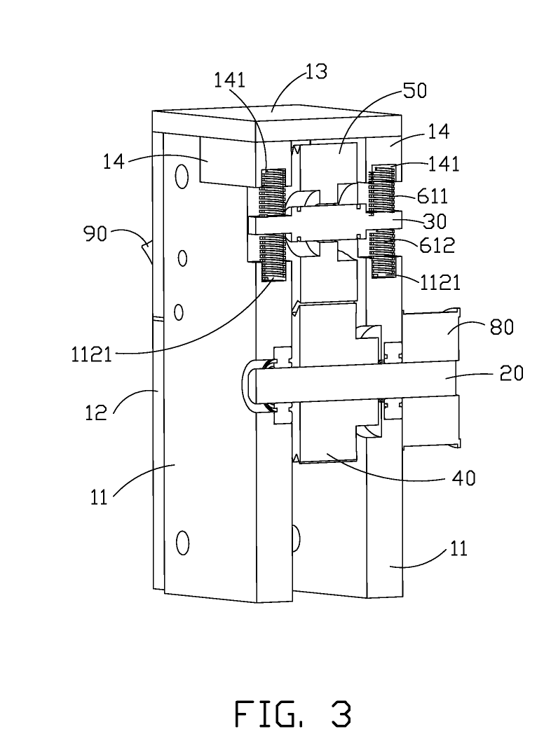

Each of the supporting boards 11 defines a groove 112 located at an upper end thereof. In the illustrated embodiment, the groove 112 is substantially “T”-shaped, and a center line of the shaft hole 111 aligns with a center line thereof. The groove 112 defines a first hole 1121 in a bottom 1122 of the groove 112(referring to FIG. 3), and includes a step 1123 in a head portion of the groove 112. The block 14 is located on the step 1123 of the groove 112, and defines a second hole 141 opposite to the first hole 1121 after assembly. In the illustrated embodiment, the first hole 1121 and the second hole 141 are blind holes.

The resilient connection device 60 includes two pairs of springs 61 corresponding to the pair of supporting boards 11, respectively. Each pair of springs 61 includes a first spring 611 and a second spring 612. The first spring 611 is partially received in the second hole 141 of the block 14 with one end thereof abutting a bottom of the second hole 141. The second spring 612 is partially received in the first hole 1121 of the groove 112 with one end thereof abutting a bottom of the first hole 1121. Each of the two ends of the floating shaft 30 is disposed between the first spring 611 and the second spring 612. In this position, the floating shaft 30 is parallel to the fixed shaft 20. The slave gear 50 is mounted on the floating shaft 30 and engages the master gear 40.

One of the sideboards 12 defines a hole 121 opposite to an engaging area (not labeled) of the master gear 40 and the slave gear 50. In use, the wire passes through the hole 121 and is fed into the engaging area to be cut off.

The covering board 13 is fixed to the tops of the supporting boards 11 and the sideboards 12 with the pair of blocks 14 fixed between the covering board 13 and the steps 1123 of the pair of the grooves 112, respectively. In this position, a direction of a force provided by the connection device 60 is parallel to the center lines of the master gear 40 and the slave gear 50, rendering a distance between the centers of the master gear 40 and the slave gear 50 adjustable to avoid blocking of the master gear 40 relative to the slave gear 50 when the cutter 100 is cutting off the scrap wire.

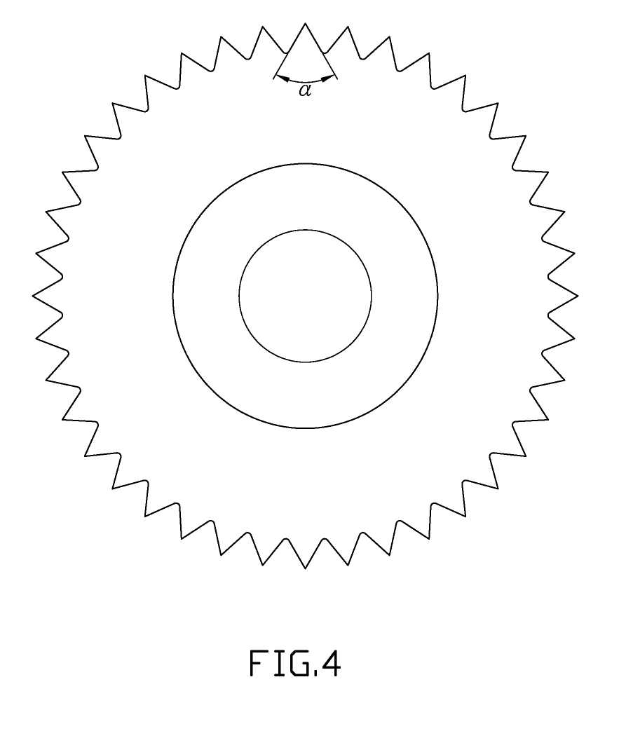

It is noted that teeth of the master gear 40 and the slave gear 50 are pointed. In the illustrated embodiment, the teeth of the master gear 40 and the slave gear 50 are substantially inverted “V” shaped. In the illustrated embodiment, an angle a of the teeth of the master gear 40 is less than 60° (referring to FIG. 4), thus, the wire is easily cut. Alternatively, the angles a of the teeth of the master gear 40 and the slave gear are each less than 60°.

Further, the cutter 100 can include a pair of roller brushes 70. The roller brushes 70 are each fixed between the pair of supporting boards 11, and abut the master gear 40 and the slave gear 50, respectively. The pair of roller brushes 70 are positioned so as to remove fragments of wire from the master gear 40 and the slave gear 50 promptly, so that the master gear 40 and the slave gear 50 function smoothly.

Further, the cutter 100 can include a feed mouth 90 including a first end 91 and a second end 92 in communication with the first end 91. The feed mouth 90 extends through the hole 121 of the sideboard 12 with the second end 92 abutting the engaging area of the master gear 40 and the slave gear 50, and the first end 91 toward an output direction of the scrap wire from a LS-WEDM machine. That is, when scrap wire is output from the LS-WEDM machine, the wire passes through the feed mouth 90 from the first end 91 to the second end 92, and is directly input to the engaging area of the master gear 40 and the slave gear 50. The feed mouth 90 is positioned so as to ensure the wire reaches the engaging area of the master gear 40 and the slave gear 50 in a correct direction.

As well, the cutter 100 can include a synchronous wheel 80 coaxial with the master gear 40 and connected to a scrap wire delivery device of the LS-WEDM machine via a synchronous belt (not shown), so that the master gear 40 rotates synchronously with the wire delivery device. That is, a rotating speed of the master gear 40 of the cutter 100 matches that of the wire delivery device of the LS-WEDM machine, reducing time spent adjusting the speeds of the cutter 100 and the LS-WEDM machine.

In use, when the master gear 40 and the slave gear 50 engage, scrap wire is cut into pieces by a cutting force generated by the mesh of the master gear 40 and the slave gear 50. In this position, a resilient force generated by the connection device 60 drives the master gear 40 and the slave gear 50 to function normally with the fragments of the scrap wire from the engaging area. That is, the scrap wire output from the LS-WEDM machine is cut promptly, resulting in space and cost for dealing with the scrap wire being significantly reduced.

While exemplary embodiments have been described, it should be understood that they have been presented by way of example only and not by way of limitation. The breadth and scope of the disclosure should not be limited by the described exemplary embodiments, but only in accordance with the following claims and their equivalent.

What is claimed is:

1. A cutter, comprising:
a base, comprising a fixed shaft and a floating shaft parallel to the fixed shaft;
a resilient connection device supporting the floating shaft;
a master gear rotatably mounted on the fixed shaft, wherein teeth of the master gear are pointed, and an angle of the teeth of the master gear is less than 60°; and
a slave gear rotatably mounted on the floating shaft and engaging the master gear;
wherein a direction of a force provided by the resilient connection device is parallel to the center lines of the master gear and the slave gear, and when scrap wire is fed into the cutter, the master gear and the slave gear collectively cut the scrap wire into pieces.

2. The cutter as claimed in claim 1, wherein the resilient connection device comprises a first pair of springs and a second pair of springs, and each of two ends of the floating shaft is supported by one of the first pair of springs and the second pair of springs, so that a distance between the master gear and the slave gear is adjustable to avoid blocking of the master gear relative to the slave gear.

3. The cutter as claimed in claim 2, wherein the base defines two first holes and two second holes opposite to the two first holes respectively, and wherein the first pair of springs is partially received in one of the two first holes and one of the two second holes, respectively, and the second pair of springs are partially received in another one of the first holes and another one of the second holes, respectively, and each of two ends of the floating shaft is disposed between one of the first and the second pair of springs.

4. The cutter as claimed in claim 3, wherein the base defines a groove comprising a step on which a block is located, and wherein the first hole is defined in the groove, and the second hole is defined in the block opposite to the first hole.

5. The cutter as claimed in claim 1, wherein the cutter comprises a pair of roller brushes fixed on the base and abutting the master gear and the slave gear, respectively.

6. The cutter as claimed in claim 1, wherein an angle of teeth of the slave gear is less than 60°.

7. The cutter as claimed in claim 1, further comprising a feed mouth corresponding to engaging teeth of the master gear and the slave gear.
